(19) United States
(12) Patent Application Publication
(10) Pub. No.: US 2022/0400630 A1
(43) Pub. Date: Dec. 22, 2022

(54) METHODS, SYSTEMS, AND APPARATUSES FOR STORING BIODEGRADABLE LITTER FOR COMPOSTING

(71) Applicants: Lukas Coleman, Menlo Park, CA (US); Brian R. Coleman, Menlo Park, CA (US)

(72) Inventors: Lukas Coleman, Menlo Park, CA (US); Brian R. Coleman, Menlo Park, CA (US)

(21) Appl. No.: 17/815,534

(22) Filed: Jul. 27, 2022

Related U.S. Application Data
(60) Provisional application No. 63/194,132, filed on May 27, 2021.

(51) Int. Cl. A01G 24/42; A01G 9/02; A01K 1/015

(52) U.S. Cl. CPC A01G 24/42; A01G 9/02; A01K 1/0152

(57) ABSTRACT

Methods, platform and receptacles, such as a composting and retail platform facilitating multipurpose use of receptacles, characterized in that the platform manages cat litter sales, uses multipurpose receptacles for shipping of cat litter, for composting, and for an additional use when filled and readied for composting.

### CROSS-REFERENCE TO RELATED APPLICATION(S)

The present application claims priority to U.S. Provisional Patent Application No. 63/194,132, filed May 27, 2021, the disclosure of which is incorporated herein by reference in its entirety.

### TECHNICAL FIELD

Various embodiments concern repositories into which litter and metabolic waste can be deposited, the repositories having multiple uses such as for shipping, composting, or being a structural elements in a structure built from such repositories.

### BACKGROUND

A litter box (also referred to as a “sandbox,” “cat box,” or “litter tray”) is a repository—usually located indoors—in which domesticated or tamed animals (also referred to as “pets”) deposit feces and urine. While litter boxes are most commonly used by cats, litter boxes could also be used by rabbits, ferrets, pigs, dogs, and other pets that either instinctively or through training will make use of such a repository. Litter boxes are normally provided for pets that are permitted to freely roam an indoor environment but who cannot go outside to excrete metabolic waste (or simply “waste”). Many caretakers of pets prefer not to let them freely roam outside for fear that the pets may succumb to outdoor dangers, such as weather, wildlife, traffic, and diseases such as feline immunodeficiency virus (FIV).

In the wild, cats naturally excrete waste in soft or sandy soil for easy burial. Over time, cats have instinctively learned to move their paws in a backward sweeping motion to cover feces. To stimulate this instinct, the bottom of a litter box is typically filled with several inches of litter box filler (or simply “litter”). Litter is a loose, granular material that absorbs moisture and odors. At a high level, litter is intended to satisfy the instinctive desire of cats to hide their scent by allowing them to bury waste.

Brands of litter comprise various materials that are intended to serve different purposes. The most common material is clay, though recycled paper “pellets” and silica-based “crystals” are also used. Some caretakers even opt to use natural dirt (or supplement litter with natural dirt) to better stimulate the natural instinct to bury waste.

### BRIEF DESCRIPTION OF THE DRAWINGS

FIG. 1 includes an illustration of a repository into which used biodegradable litter can be stored.

FIG. 2 illustrates an example of a repository that can be communicatively connected to electronic devices or networks via a wireless protocol.

FIG. 3 illustrates a network environment that includes a management platform.

FIG. 4 includes a high-level illustration of a process by which a caretaker deposits biodegradable litter and waste into repositories and then uses those repositories for some other purpose.

FIG. 5 includes an example arrangement of modules that allows biodegradable litter and waste to be deposited directly into a repository or compost bin.

Various features of the technologies described herein will become more apparent to those skilled in the art from a study of the Detailed Description in conjunction with the drawings. Embodiments are illustrated by way of example and not limitation in the drawings. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

The first commercially available litter in the United States was Kitty Litter in 1947. Kitty Litter represented the first large-scale use of clay in litter boxes as sand or natural dirt was previously used by most caretakers. Clay litter is not only more absorbent than sand and natural dirt but can also be manufactured into large grains or clumps, making it less likely to be tracked from the litter box. Over time, Kitty Litter became a genericized trademark, and thus is now used to denote any type of litter—including those designed for other pets.

Historically, litter was non-clumping. Simply put, non-clumping litter does not “clump” when exposed to moisture, and so feces simply remained on the surface of non-clumping litter while urine permeated through non-clumping litter toward the bottom of the litter box. Non-clumping litter is normally made of zeolite, diatomite, sepiolite, and the like. Litter boxes with non-clumping litter tend to give off a strong odor, in part because of the difficulty of properly clearing waste from those litter boxes.

Clumping litter was developed in an effort to address this issue. Clumping litter was first developed using calcium bentonite. Calcium bentonite is a swelling clay that is able to absorb large quantities of moisture. Most clumping litters are made from granulated bentonite clay, which clumps together when moistened and forms a solid mass separate from the other litter in the litter box. This solid mass can be easily removed and disposed of without changing the entire contents of the litter box. Because of the clumping effect, manufacturers usually instruct caretakers not to flush clumping litters down the toilet due to the risk of clogging.

Clumping litters are normally made from natural products. While the primary ingredient of most clumping litters is granulated bentonite clay, other ingredients may be included. For example, clumping litters could also contain quartz, diatomaceous earth, crystalline silica, or silica dust. Over the last several years, manufacturers of clumping litters—especially clay-based ones—have been criticized because the ingredients of those litters are commonly obtained via strip mining in an environmentally degrading process. Many caretakers have begun looking for alternatives to conventional clumping litters.

One of these alternatives is silica gel litter (also referred to as “crystal litter”) that is comprised of silicon dioxide in a porous granular form. Crystal litter has the highest absorbency of any litter. Moreover, crystal litter has excellent moisture control and odor elimination capabilities over extended intervals of time. However, it is important to lightly stir crystal litter on a frequent (e.g., daily) basis, otherwise urine can pool in the litter box. Over time, crystal litter will become saturated with urine. However, because crystal litter does not clump, it is not necessary to constantly replenish crystal litter.

While non-clumping litter, clumping litter, and silica gel litter offer various advantages and disadvantages, all of these litters share one downside in common, namely, that using these litters created significant waste. Each year, more than two million tons of litter ends up in landfills in the United States alone. These litters are not biodegradable or renewable, and therefore add to the waste burden. For this reason, some caretakers have begun using biodegradable litters (also referred to as “compostable litters”). Biodegradable litter can be eliminated completely by safely composing the used litter at home.

Assume, for example, that a caretaker of a pet wishes to use biodegradable litter. While the process of using the biodegradable litter may be straightforward, the process of composting the biodegradable litter may not be. Simply put, many caretakers do not have access to a compost collection receptacle (also referred to as a “compost bin”) that is suitable for composting. Introduced here are approaches to composting biodegradable litter, as well as repositories for accomplishing the same.

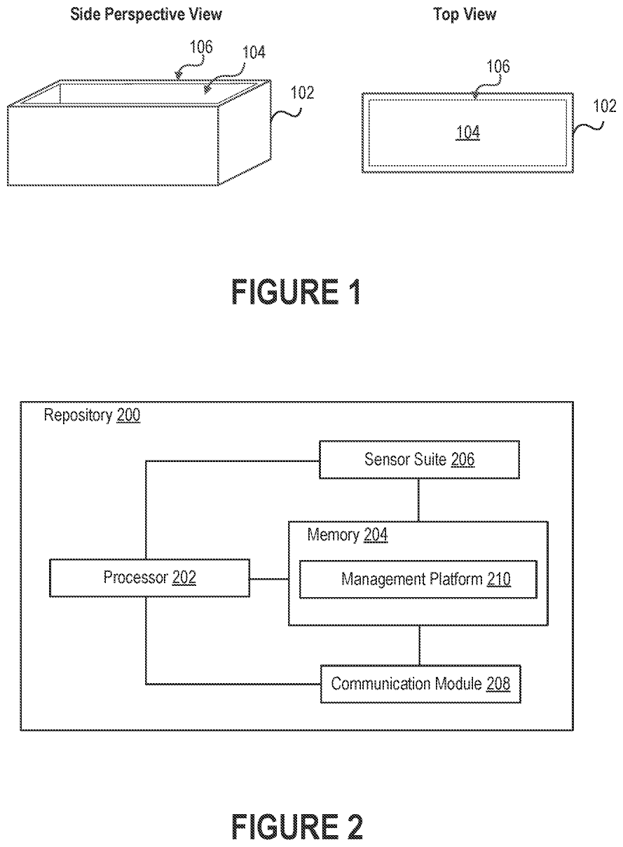

FIG. 1 includes an illustration of a repository into which used biodegradable litter can be stored. The repository (also referred to as a “receptacle”) is representative of a structural body 102 with a cavity 104 defined therein. Here, the structural body 102 has the form of a rectangular prism with an open surface along its top face. However, the structural body 102 could be in the form of a cube, sphere, cone, cylinder, pyramid, triangular prism, etc. Regardless of its form, the structural body 102 may have one or more apertures 106 defined along its surface through which the cavity 104 is accessible.

The structural body 102 may be comprised of a durable material that provides rigidity under pressure (e.g., force applied by the biodegradable litter against the sidewalls of the cavity 104). For example, the structural body 102 may be comprised of metal, concrete, ceramic, granite, clay, plastic, or any combination thereof. As further discussed below, the repository may serve as a decorative element in which biodegradable litter can be stored while composting, so the structural body 102 may be made from any suitable material or combination of materials. Since the repository may serve as a decorative element, decorative features may be arranged along the surface of the structural body 102. Examples of decorative features include paint, glaze, paneling (e.g., comprised of wood or plastic), and the like.

Generally, the structural body 102 is designed so that the repository can be easily moved, even after being partially or entirely filled with biodegradable litter. Because the repository can be moved, the length of time that it takes for the biodegradable litter stored therein may be of little importance. Movability can be achieved in several ways. In some embodiments, the structural body 102 is comprised of a durable yet lightweight material (e.g., plastic) that allows the repository to simply be moved using, for example, the hands or a dolly. Additionally or alternatively, the structural body 102 may include, or be connected to, structural features that allow the repository to be easily moved. For example, one or more handles may be fixedly secured to the structural body 102. As another example, the structural body 102 may have recesses along some or all of the sides that can be used for grasping. For instance, recesses may be located along opposing sides of the structural body 102 that are designed to accommodate the fingers. As another example, one or more caster wheels (also referred to as “casters”) may be fixedly secured to the structural body 102 so as to allow the repository to be rolled from one location to another location.

In some embodiments, the repository serves as a “dumb” receptacle for biodegradable litter and waste. In other embodiments, the repository serves as a “smart” receptacle for biodegradable litter and waste. FIG. 2 illustrates an example of a repository 200 that can be communicatively connected to electronic devices or networks via a wireless protocol, such as Bluetooth, Zigbee, Near-Field Communication (NFC), Wi-Fi, and the like.

“Smart” functionality may allow the repository 200 to more actively engage caretakers. For example, after filling the repository 200 with biodegradable litter and waste, a caretaker may opt to add seeds or plants as further discussed below. In such a scenario, the caretaker may plan to use the repository as a planter while compositing occurs. If the repository 200 is communicatively connected to another electronic device (e.g., a mobile phone), then information can be readily exchanged between the repository 200 and the other electronic device. For example, the repository 200 may indicate to the other electronic device where it is located, whether its contents are composting as expected, etc.

The repository 200 can include a processor 202, memory 204, sensor suite 206, and communication module 208. Each of these components is discussed in greater detail below. Those skilled in the art will recognize that different combinations of these components may be presenting depending on the desired functionalities of the repository 200.

The processor 202 can have generic characteristics similar to general-purpose processors, or the processor 202 may be an application-specific integrated circuit (ASIC) that provides control functions to the repository 200. As shown in FIG. 2, the processor 202 can be connected to all components of the repository 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the management platform 210) and sensor suite 206. Note that the memory 204 is merely an abstract representation of a storage environment. The memory 204 could be comprised of actual memory chips or modules.

Various sensors may be implemented in the repository 200. Collectively, these sensors may be referred to as the “sensor suite” 206 of the repository 200. For example, the repository 200 may include a temperature sensor that is operable to measure the temperature of its contents (e.g., the biodegradable litter and waste). Since temperature is an important aspect of composting, monitoring the temperature may be critical to understanding whether compositing is proceeding as intended. Note that the temperature could be generated on a continual basis (e.g., in accordance with a schedule programmed in the memory 204) or ad hoc basis (e.g., when instructed to do so by the management platform 210). As another example, the repository 200 may include a moisture sensor that is operable to measure the water content of its contents. The moisture sensor may be useful if the repository 200 is to be used as a planter or structural element (e.g., a “brick” in a wall). Like the temperature sensor, the moisture sensor may be able to generate measurements on a continual basis or ad hoc basis. As another example, the repository 200 may include a nutrient sensor that is operable to measure nutrient levels of its contents. Most nutrient sensors rely on optical and/or electrochemical approaches to perform in situ soul analysis. Optical nutrient sensors generally use spectroscopy to identify the magnitude of reflected and absorbed energy by ions in the “soil.” Electrochemical nutrient sensors generally use ion-selective electrodes to initiate a current or voltage output that reflects the concentration of target ions.

The communication module 208 may be responsible for managing communications between the components of the repository 200, or the communication module 208 may be responsible for managing communications with other electronic devices (e.g., a mobile phone or server system). The communication module 208 may be wireless communication circuitry that is designed to establish communication channels with other electronic devices. Examples of wireless communication circuitry include antenna modules configured for cellular networks (also referred to as “mobile networks”) and integrated circuits (also referred to as “chips”) configured for Bluetooth, Wi-Fi, NFC, and the like.

Other components could also be included in the repository 200. For example, the repository 200 may include a beacon that is capable of emitting an electronic signature. Examples of beacons include Bluetooth beacons, USB beacons, and infrared beacons. A beacon may be able to communicate with another electronic device via a wireless communication channel. Thus, the repository 200 may be able to indicate to another electronic device that it is located in a given proximity by emitting the electronic signature via the beacon. Similarly, electronic signatures emitted via beacons external to the repository 200 may be received by the communication module 208.

For convenience, the management platform 210 may be referred to as a computer program that resides in the memory 204 and is executed by the processor 202. However, the management platform 210 could be comprised of software, firmware, or hardware that is implemented in, or accessible to, the repository 200.

At a high level, the management platform 210 may be responsible for managing the repository 200. For example, the management platform 210 may be able to prompt a sensor included in the sensor suite 206 to generate a measurement and then examine the measurement. Additionally or alternatively, the management platform 210 may forward the measurement (or analyses of the measurement) to the communication module 208 for transmission to a destination. The destination could be a computer program that is executed by a mobile phone associated with the caretaker responsible for depositing the biodegradable litter and waste into the repository 200, or the destination could be a computer program that is executed by a server system responsible for managing data associated with various repositories. Thus, the management platform 210 may examine data produced by the sensor suite 206 to gain a better understanding of the contents of the repository 200, or the management platform 210 may facilitate such analysis by forwarding this data to a destination.

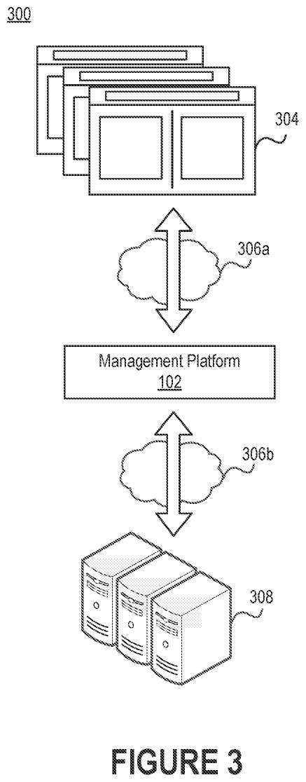

FIG. 3 illustrates a network environment 300 that includes a management platform 302. Individuals can interact with the management platform 302 via interfaces 304. For example, a caretaker may be able to access interfaces through which information regarding repositories that she has filled with biodegradable litter can be provided. Some interfaces are configured to facilitate interactions between caretakers and repositories. If, for example, a caretaker has opted to use a repository as a planter, the caretaker may be able to indicate that an automatic watering system should be shut off responsive to determining—based on data generated by the repository—that the contents are still moist. Other interfaces are configured to serve as informative dashboards.

As shown in FIG. 3, the management platform 302 may reside in a network environment 300. Thus, the management platform 302 may be connected to one or more networks 306a-b. The networks 306a-b can include personal area networks (PANs), local area networks (LANs), wide area networks (WANs), metropolitan area networks (MANs), cellular networks, the Internet, etc. Additionally or alternatively, the management platform 302 can be communicatively coupled to one or more electronic devices over a short-range wireless connectivity technology, such as Bluetooth, NFC, Wi-Fi Direct (also referred to as “Wi-Fi P2P”), and the like.

The interfaces 304 may be accessible via a web browser, desktop application, mobile application, or over-the-top (OTT) application. For example, a caretaker may be able to access an interface through which information can be provided via a mobile application executing on a mobile phone. Such information can include the identifier for a repository, as well as its location, contents, planned use, etc.

In some embodiments, at least some components of the management platform 302 are hosted locally. That is, part of the management platform 302 may reside on the repository as shown in FIG. 2, or part of the management platform 302 may reside on the electronic device used to access one of the interfaces 304. For example, the management platform 302 may be embodied as a mobile application executing on a mobile phone associated with a caretaker. Note, however, that the mobile application may be communicatively connected to a network-accessible server system 308 on which other components of the management platform 302 are hosted.

In other embodiments, the management platform 302 is executed entirely by a cloud computing service operated by, for example, Amazon Web Services®, Google Cloud Platform™, or Microsoft Azure®. In such embodiments, the management platform 302 may reside on a network-accessible server system 308 comprised of one or more computer servers.

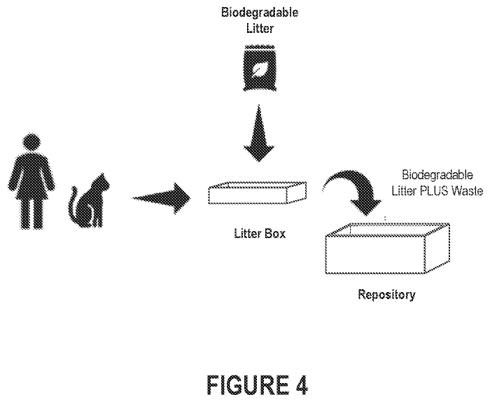

FIG. 4 includes a high-level illustration of a process by which a caretaker deposits biodegradable litter and waste into repositories and then uses those repositories for some other purpose. For example, the caretaker may utilize a repository as a decorative element, functional element (e.g., a planter) or structural element. Assume, for example, that the caretaker has a cat for whom she routinely purchases biodegradable litter. This biodegradable litter could be purchased from a manufacturer of repositories, or this biodegradable litter could be purchased from a retailer (e.g., Target, PetSmart, Petco).

Initially, the caretaker deposits biodegradable litter into a litter box. Over time, the cat excretes waste into the litter box. When this occurs, the caretaker can remove the waste from the litter box and then deposit the waste (and some biodegradable litter) into a repository. This repository may serve as a receptacle for waste produced by the cat. Alternatively, the caretaker may deposit the waste into a compost bin, and then relocate the waste from the compost bin to the repository at some later point in time.

One important aspect of the repository is that, once filled, it can be converted into a useful item. For example, the caretaker may be allowed to add seeds, plants, nutrients, and the like in order to convert the repository into a planter. These materials may be obtained from the manufacturer of the repository or another source. As another example, the caretaker may be allowed to enclose the cavity and then use the repository as a structural element (e.g., in building a retaining wall or decorative border). Biodegradable litter and waste takes a long time to fully compost. However, because the repository has some additional functionality, the length of this interval of time is less important. Simply put, the caretaker may be able to gain some functionality from the repository while composting occurs.

Also introduced herein is modular building units (also referred to as “modular buildings”) for pets. As mentioned above, many caretakers opt not to allow their pets freely roam outside for fear that the pets may succumb to outdoor dangers. A modular building is comprised of prefabricated sections called “modules.” Modularity involves constructing these sections away from the building site (e.g., a home) and then delivering them to the building site or another site (e.g., a retailer). Installation of the modules can be completed entirely on site. Thus, a caretaker may be able to easily build a modular building for her pet by simply securing various modules to each other. Note, however, that the module may be designed to allow for various configurations and styles.

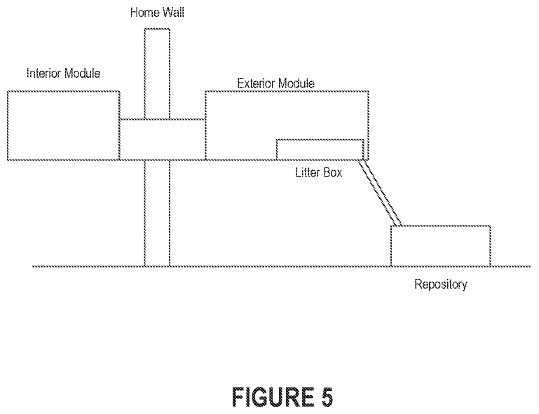

At a high level, the modules are designed so as to allow a caretaker to construct a modular building unit inside and/or outside her home. Moreover, the modules may be designed so as to allow waste to be deposited into either repositories (e.g., the repositories of FIGS. 1-2) or compost bins. FIG. 5 includes an example arrangement of modules that allows biodegradable litter and waste to be deposited directly into a repository or compost bin.

As an example, one of the modules may be intended to serve as a dedicated “restroom” that includes a litter box. This module may be designed so that litter can be added to the litter box when necessary. For instance, this module may include a lockable “window” that, when unlocked, provides access to the litter box and, when locked, prevents the pet from escaping.

Moreover, this module may be designed such that waste deposited into the litter box can be deposited directly into a repository or compost bin.

In some embodiments, this module is designed to accommodate technology that automated the litter box emptying procedure. Thus, this module can be designed so that waste is automatically deposited into the repository or compost bin without requiring any input from the caretaker. For example, this module may include (or be designed to accommodate) an electric combing mechanism that automatically removes waste from the litter box. Electric combing mechanisms normally deposit waste into a sealed container; here, however, the waste can be deposited directly into the repository or compost bin.

In other embodiments, this module is designed such that the entire litter box can be displaced. For example, a mechanical lift may be located under one end of the litter box. When it is determined that the cat is no longer in the litter box (e.g., based on a signal produced by an optical sensor, pressure sensor, or audio sensor), the mechanical lift may be actuated so that the biodegradable litter and waste slides into the repository or compost bin.

### Remarks

The foregoing description of various embodiments has been provided for the purposes of illustration and description. It is not intended to be exhaustive or to limit the technology to the precise forms disclosed. Many modifications and variations will be apparent to one skilled in the art. Embodiments were chosen and described in order to best describe the principles of the technology and its practical applications, thereby enabling those skilled in the relevant art to understand the disclosure, the various embodiments, and the various modifications that are suited to the particular uses contemplated.

Although the Detailed Description describes certain embodiments, the technology can be practiced in many ways no matter how detailed the Detailed Description appears. Embodiments may vary considerably in their implementation details, while still being encompassed by the disclosure. Particular terminology used when describing certain features or aspects of various embodiments should not be taken to imply that the terminology is being redefined herein to be restricted to the specific features or aspects of the technology with which that terminology is associated. In general, the terms used in any claims that issue on an application based on this disclosure should not be construed to limit the technology to the specific embodiments described in the specification, unless those terms are explicitly defined herein. Accordingly, the actual scope of the technology encompasses not only the described embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon.

1. A method for providing a composting structure:
receiving at a site one or more multipurpose structural receptacles containing fresh cat litter;
filing the one or more multipurpose structural receptacles with waste for composting;
sealing the one or more multipurpose structural receptacles; and
assembling the structure using the one or more multipurpose structural receptacles,
whereby each receptacle serves as a shipping, composting and structural receptacle.

2. The method of claim 1 wherein the waste includes used cat litter.

3. The method of claim 1, wherein the receptacles include sensor and computing elements used to facilitate a platform for tracking and managing.

4. A method for providing a planter:
receiving at a site a multipurpose receptacle, fresh cat litter, a plant sapling or other form, and other materials for composting;
filling the receptacle as needed with used cat litter, and the other materials; and
planting the plant sapling or other plant form in the receptacle,
whereby composting can occur in the readied receptacle.

5. A method as recited in claim 4, wherein the receptacle is further purposed for shipping with the compost and further including: readying the receptacle for shipment, and shipping the receptacle with plant and compost to a third party.

6. A composting and retail platform facilitating multipurpose use of receptacles, characterized in that the platform manages cat litter subscriptions, uses multipurpose receptacles for shipping of cat litter, for composting, and for an additional use when filled and readied for composting.

7. The platform of claim 6, wherein the receptacles include sensor and computing elements for tracking and managing.

8. A multipurpose receptacle suitable for shipping cat litter, composting cat litter, and having at least a third purpose intentionally designed into the receptacle.

9. The multipurpose receptacle of claim 8, wherein the third purpose is for arranging into a structure utilizing other multipurpose receptacles.

10. The multipurpose receptacle of claim 8, wherein the third purpose is for use as a planter.
